(19) United States
(12) Patent Application Publication
(10) Pub. No.: US 2010/0015911 A1
(43) Pub. Date: Jan. 21, 2010

(54) SYSTEMS FOR AUTOMATIC AUDIENCE SIZE MEASUREMENT AND INTERACTIVITY

(76) Inventor: EDWARD REYNOLDS, ANAHEIM, CA (US)

Correspondence Address: LOZA & LOZA LLP, 305 N. SECOND AVENUE, #127, UPLAND, CA, 91786-6064, US

(21) Appl. No.: 12/176,384

(22) Filed: Jul. 20, 2008

(51) Int. Cl. H04H 60/33

(52) U.S. Cl. 455/2.01

(57) ABSTRACT

A system for automatically measuring the size of a radio or television audience at any particular time is provided. In the system, a remote computer may identify the broadcast stations to which listening devices, such as radios or televisions, are tuned. To identify the broadcast stations, the remote computer commands the listening device instructing/commanding the listening device to poll its radio receiver tuner to determine the frequency it is tuned to. This information is then transmitted from the listening device to the remote computer where it may be used to determine what broadcast station the listening device is tuned to. This data is then stored and accumulated, so that over time the listening habits of the user may be identified. The collected data may be used by broadcast stations to determine the cost of advertisements. Additionally, the system provides for the monetization of advertising by charging advertisers for downloads.

### FIELD

The present application relates to radio communication systems, and more particularly, to systems and methods for interacting with a radio, collecting radio listening data and advertising using the listening data.

### BACKGROUND

Radio station ratings, which reflect the average size of the audience of a radio broadcast, are very valuable to an advertiser because they tell the size of the audience for the advertiser's commercial. The fees that a radio station charges to broadcast an advertisement on the air are largely dependent upon the radio station ratings, so it is important to accurately measure the ratings.

One existing method of measuring an audience size is using an audience research company, such as Arbitron®, Inc. Audience research companies randomly select a limited number of people to maintain a written log or diary for a specified time period, such as for a week, for describing their listening habits, i.e., each radio program listened to. At the specified period, the completed diaries are returned to the audience research company which then manually compiles the data.

Another existing method of measuring an audience size is to select individuals to carry a device, developed by Arbitron®, Inc., known as the Portable People Meter (PPM). The PPM is worn like a pager and detects hidden audio tones within a station or network's audio stream, logging each time it finds such a signal. At the end of the day, the data recorded by the PPM is transferred to a base station which then transmits the data to the audience measurement company which uses the data to determine ratings of the radio stations.

Both of these existing methods are inherently inaccurate because the first method depends on the measurement company's ability to select a representative group of people who ostensibly represent the likes and dislikes of the hugely larger actual audience, and the diligence of the participants. The second method is flawed due to the limited number of participants and the diligence of the limited number of participants in regularly participating by carrying the device. Consequently, a system and method is needed for accurately measuring the audience size of radio broadcasts.

### SUMMARY

In one aspect of the present application, a method for collecting audience data is provided. The method includes establishing a wireless communication link between a remote computer and at least one listening device; polling the at least one listening device to identify a broadcast frequency that the at least one listening device is tuned to; transmitting the broadcast frequency, over the wireless communication link, to the remote computer; comparing the broadcast frequency to a list of assigned frequencies to determine a broadcast station identifier corresponding to the broadcast frequency; and storing the broadcast station identifier in a database.

In another aspect of the present application, a remote computer used to collect audience data is provided. The remote computer includes a memory device; and a processor coupled with the memory device. The processor is configured to poll at least one listening device, at the predetermined intervals, to identify a broadcast frequency that the at least one listening device is tuned to, or a different broadcast frequency then when previously polled; receive the broadcast frequency from the at least one listening device and compare the broadcast frequency to a list of assigned frequencies to determine a broadcast station identifier corresponding to the broadcast frequency; and store the broadcast station identifier in a database.

In yet another aspect of the present application, a method for responding to audio information broadcast on a listening device is provided. The method includes establishing a wireless communication link between a remote computer and a listening device, the wireless communication link being established in response to a listener requesting to download an audio file; authenticating listening device; scanning the audio file for identifier data and transmit to the computer; searching a database to find a match to the identifier data; providing a listener with costs for downloading the audio file; and requesting the listener confirm the download by entering a pin number; downloading the audio file; and resuming regular programming.

In yet another aspect of the present application, a method for interacting with a listening device is provided. The method includes establishing a wireless communication link between a remote computer and a listening device, the wireless communication link being established in response to a listener entering a pre-determined sequence of numbers; requesting additional information related to a broadcast on the listening device; determining the broadcast the listening device is tuned to by identifying a broadcast frequency; comparing the broadcast frequency to a list of assigned frequencies to determine a broadcast station identifier corresponding to the broadcast frequency; identifying the broadcast information for which additional information is being requested; and transmitting the additional information to the listener. The advertiser, by prior agreement, could be charged for the download, thus monetizing the advertisement.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a radio communication system, in accordance with an exemplary embodiment.

FIG. 2 is a block diagram illustrating a remote computer configured to communicate with one or more listening devices.

FIG. 3 is a block diagram illustrating a listening device configured to communicate with a remote computer.

FIG. 4 illustrates a front panel of a listening device, in accordance with an exemplary embodiment.

FIG. 5 is a flow diagram illustrating a method for collecting listening data from one or more listening devices.

FIG. 6 is a flow diagram illustrating a method for responding to audio information broadcast on a listening device.

FIG. 7 is a flow diagram illustrating a method for downloading an audio file or information broadcast by a broadcasting station.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The term “communication system” refers to a physical device capable of receiving and/or transmitting wired or wireless signals, such as voice and/or data signals or messages. The term “listening device”, after adapted, refers to any type of device for receiving and/or transmitting information, such as a car radio, portable radio, television, mobile phone, pager, personal digital assistant, radio, etc. The term “broadcasting station” refers to a satellite radio or subscription radio and/or AM or FM radio and digital television radio (or DTR), or one that can broadcast to any of the devices listed above.

In one aspect, a system for automatically measuring the size of an audience listening to, or watching, a broadcast at any particular time is provided. In the system, standard listening devices, such as radios and/or televisions, are adapted to receive and transmit data. A remote computer in the system may be used to identify the broadcast stations to which listening devices are tuned. To identify the broadcast stations, the remote computer commands/instructs the listening device to poll its receiver tuner to determine the frequency it is tuned to. This information is then transmitted from the listening device to the remote computer where it may be used to determined what broadcast station the listening device is tuned to. This may then be stored and accumulated, so that over time, the listening habits of the user may be identified.

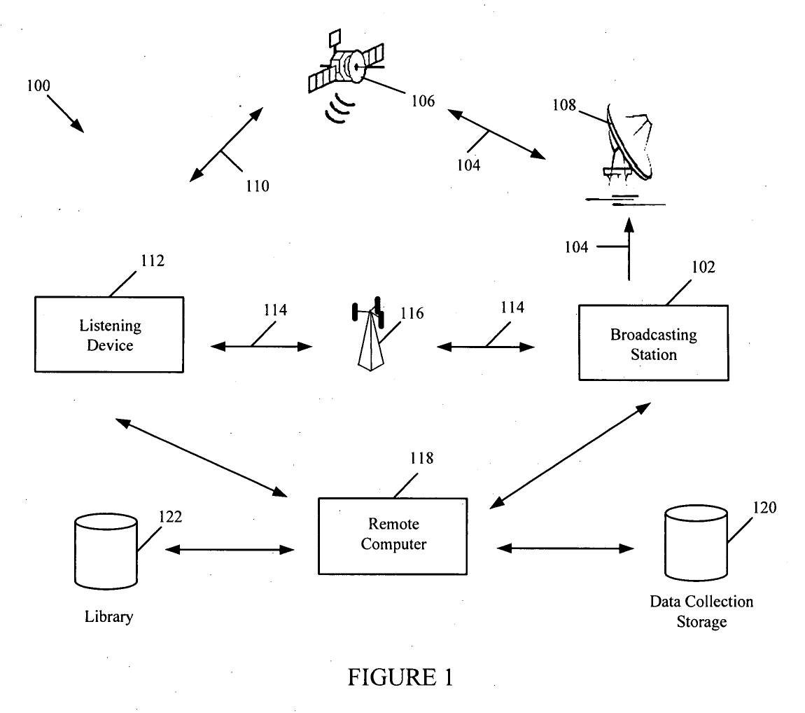

FIG. 1 illustrates a communication system 100 in accordance with an exemplary embodiment. The communication system 100 may include, for example, a broadcasting station 102 that transmits signals 104 containing audio and/or video content to a geostationary satellite 106 by way of a satellite antenna 108. In turn, the satellite 106 may transmit signals 110 having that audio content to one or more listening devices 112. The broadcasting station 102 may also transmit AM or FM radio signals 114, over specific frequencies, containing audio and/or video content to the listening device by way of an antenna or radio tower 116.

A remote computer 118 may serve to manage the collection of listening data on radio audiences received from the one or more listening devices 112 and manage requests for data from the one or more listening devices 112. The listening data received from the listening devices 112 may be stored in a database or data collection storage device 120 for later retrieval, compilation and analysis by a research audience company, radio station or any other person or groups of people with an interest in the listener data. The listening data collected may include listening behavior, i.e., what radio station the listening device was tuned to and when, as well as geographic and demographic information about listening audiences. This collected data may be used for marketing and research by advertisers and others. Additionally, the remote computer may transmit information or data to the listening device, including, but not limited to advertising, and instructions for the user/listener.

Additionally, a listener (or user) may request information on products/services described on the air or may download audio files of songs that are being broadcast by the broadcasting station 102. The broadcasting station 102 may store some or all of the information on the products/services described on the air as well as audio files in a library database 122. To download an audio file or request additional information, the listener may send a request, using the listening device, to the remote computer 118. Once the request is received, the remote computer may search the library database 122 for the audio file or additional information. If the audio file or additional information is found, the remote computer may notify the listener that the audio file or additional information has been found and may ask the listener to confirm the request. The advertiser of the products/services, by prior agreement, could be charged for the download, thus monetizing the advertisement.

In operation, as discussed above, the listening device may receive satellite signals and/or standard radio broadcast signals. The listening devices may be located in mobile environments, such as land vehicles, aircraft, watercraft, handheld devices and the like. The listening devices also may be in stationary units for residential uses, such as home entertainment, or commercial uses, such as offices.

The communication system 100 may operate in one or more signal modulation and/or spectrum management schemes and/or communication standards, such as Code Division Multiple Access (CDMA), Global System for Mobile Communications (GSM), Time Division Multiple Access (TDMA), Terrestrial Trunked Radio (TETRA), Specialized Mobile Radio (SMR), Integrated Digital Enhanced Network (iDEN), Frequency Modulated radio (FM), Amplitude Modulated radio (AM), among others. The communication system 100 may also be configured to transmit instructions to listeners.

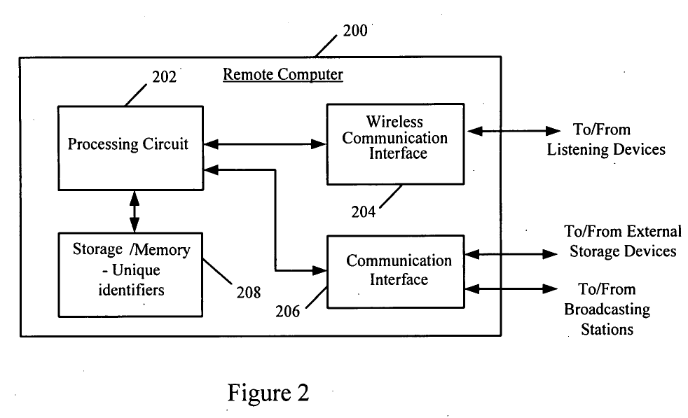

FIG. 2 is a block diagram illustrating a remote computer 200 configured to collect listening data from, or provide information or data to, one or more listening devices. The remote computer 200 may include a processing circuit 202 (e.g., processor, processing module, etc.) coupled to a wireless communication interface 204 to communicate over a wireless network, a communication interface 206 to communicate with external storage devices, such as databases, and/or broadcasting stations, and a storage device 208 to store a list of unique identifiers associated with identified listening devices. The list of unique identifiers may be used as address locations in the external storage devices to store and locate information for that particular listening device associated with the unique identifier. The processing circuit 202 may be configured to compile and analyze the data or information, such as radio listening data, for the broadcasting stations, advertisers or others that may request the data.

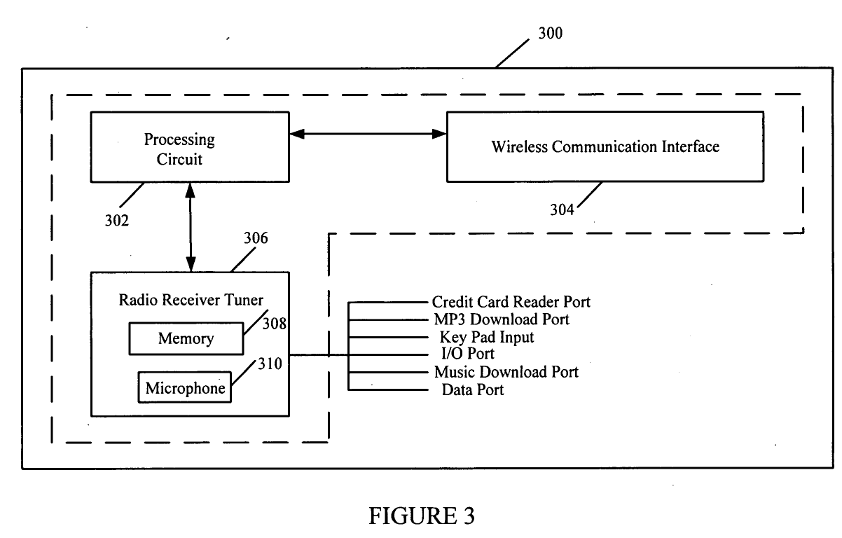

FIG. 3 is a block diagram illustrating a listening device 300 configured to communicate with the remote computer 200 of FIG. 2. The listening device 300 may include a processing circuit 302 (e.g., processor, processing module, etc.) coupled to a wireless communication interface 304 to communicate over a wired and wireless network, and a radio receiver (or transceiver) tuner 306 to receive radio broadcasts in the form of audio files. The processing circuit 302 may be configured to read the header or tag information from the audio file to determine its identity, and compile and transmit this information or data to the remote computer 200.

The remote computer 200 may transmit a command to the listening device instructing/commanding the listening device to poll its radio receiver tuner 306 to determine the frequency it is tuned to, so that it may obtain over time, the listening habits of the user. The radio receiver tuner 306 may also include one or more connectors for attaching external devices to the listening device 300. The connectors may include, but are not limited to, a universal serial bus (USB), audio connectors, video connectors, I/O ports, music download ports, data ports, and the like for attaching devices. The external devices may include card readers, MP3 players, keyboards/keypads, and the like. A memory device 308 may be located within the radio receiver tuner 306 for storing downloaded information or files so that the listener may store the information without having to have an external device attached. In an alternative embodiment, the memory device 308 may be located within the listening device but external to the radio receiver tuner 306. The listening device 300 may also include a microphone 310 for receiving and recording the sound on the memory device 308 in the radio receiver tuner 306. The microphone 310 may allow the listener to verbally enter information, such as passwords, and confirm the downloading of data, as described below, so that the listener may keep his hands free for driving.

In one embodiment, the wireless communication interface and processing circuit may be manufactured concurrently with the radio receiver tuner 306. Alternatively, the wireless communication interface 304 and processing circuit 302 may be installed later to pre-existing radio receiver tuners. The wireless communication interface 304 and processing circuit 302 may be included in one integrated circuit or may be included as part of a larger integrated circuit within the radio receiver tuner 306.

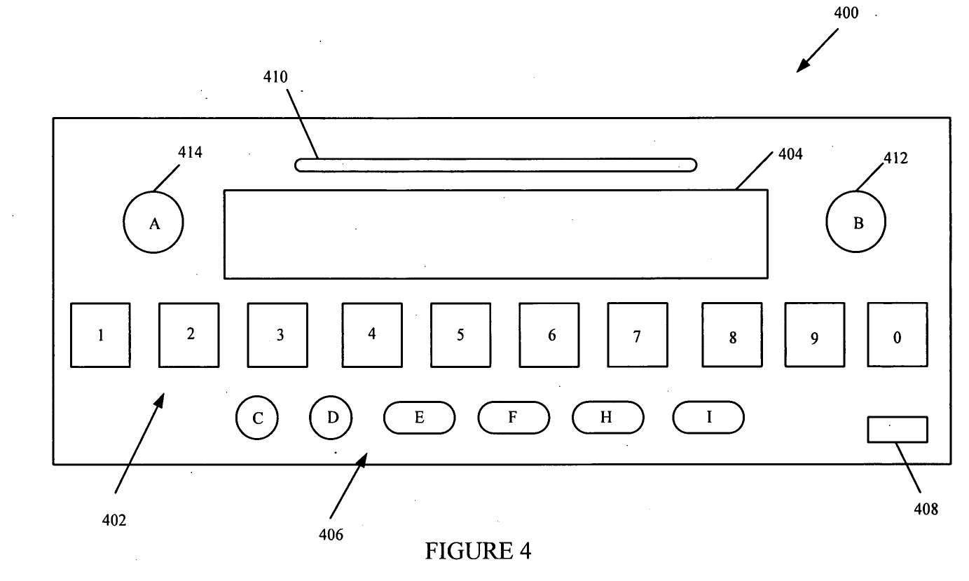

FIG. 4 illustrates a front panel of a listening device 400 used to communicate with a remote computer and collect radio listening data, according to one embodiment. A plurality of selection or preset buttons 402 may be positioned on the front panel 400 and may be operatively connected to an AM/FM radio receiver tuner. The individual preset buttons 402 may correspond to preselected tuned radio frequencies so that upon depression of a selected preset button when the radio receiver tuner is in operation, the controller preselects a desired radio frequency. Additionally, the preset buttons 402 may have alpha-numeric designations so that they may be used as a numeric keypad by a listener for entry of information, including but not limited to passwords for authentication, verify the acceptance of data/information to be downloaded and to cancel requests for information.

The listening device may also include a display 404 for displaying the frequency and/or name of the broadcasting station it is tuned to, as well as instructions to the listeners for requesting information and/or audio files. A plurality of connectors 406 may also be positioned on the front panel 400 for attaching external devices, as described above. The connectors may include, but are not limited to, a universal serial bus (USB), audio connectors, video connectors, I/O ports, music download ports, data ports, and the like for attaching devices. The external devices may include card readers, MP3 players, keyboards/keypads, and the like.

As described above, the listening device may also include a microphone 408 for receiving sound and recording the sound on a memory device in the radio receiver tuner. The microphone 408 may allow the listener to verbally enter passwords and confirm the downloading of data so that the listener may keep his hands free for driving. In an alternative embodiment, the microphone 408 may be separate from the listening device 400. The listening device may also include a compact disc (CD) player 410 as well as knobs for adjusting volume 412 and frequency 414.

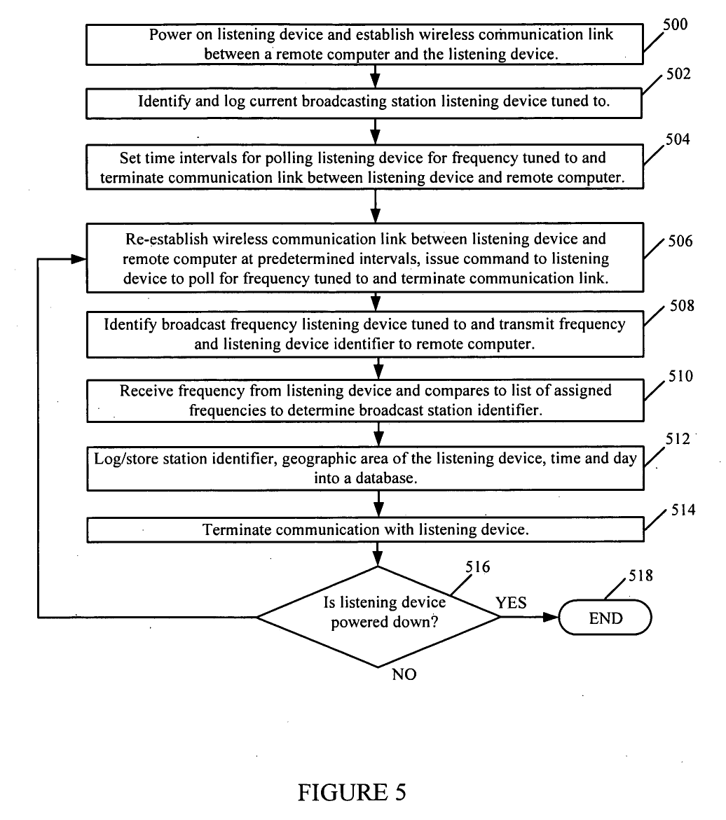

FIG. 5 is a flow diagram illustrating a method for measuring audience sizes of radio broadcasts by identifying radio stations to which radios or listening devices in specific regions or areas are tuned. Initially, a listener powers/turns on a listening device causing a wireless communication link to be established with a remote computer 500. The wireless communication link is established by the listening device calling an assigned telephone number of the remote computer. In one embodiment, a telephone number and serial number may be assigned to each listening device at the factory. The remote computer may also be assigned a telephone number. The serial number may be permanently assigned to the listening device and typically the telephone number is also permanently assigned. However, in an alternative embodiment, the telephone number may be set at the factory in an erasable programmable read-only (EPROM) and later changed in the field by a technician. Additionally, a Flash EPROM may be used allowing the telephone number in the listening device to be remotely programmable and changed by the remote computer.

One or more remote computers may be used to collect the data from the multiple listening devices in use. The listening device may be portable or in a fixed location including in an automobile, a user's residence, a user's place of business etc.

Upon establishing the communication link, the listening device may transmit a unique listening device identifier to the remote computer so that the remote computer may identify each listening device and may log and track data, according to the unique listening device identifier. The remote computer may identify and log the current broadcasting station (i.e. frequency) the listening device is tuned to 502. As described above, the unique listening device identifier may be used as an address for locating and storing data collected from the listening device. The listening device identifier may be a specific telephone number assigned to the listening device or its serial number. The telephone number of the remote computer may be preset.

Once the unique listening device identifier is received by the remote computer, an acknowledgement may be sent from the remote computer to the listening device to confirm that communication has been established. When the communication is established, time intervals may be set for polling the listening device for the frequency it is tuned to. Once the time intervals have been set, communication between the listening device and the remote computer may be terminated 504.

The remote computer may be programmed to poll each listening device at predetermined intervals, for example once every 10 minutes. However, the actual polling times may be changed to satisfy advertisers and others and could be changed to poll more or less often during various times of the day. The polling intervals may be changed by the remote computer.

At the predetermined intervals, the wireless communication link between the one or more of the listening devices and the remote computer may be re-established to determine the current frequencies that they are tuned to 506. The remote computer may poll all the listening devices at the same time or may stagger the time in which they are polled. Once communication is re-established, a command may be issued from the remote computer to the listening device to poll for the frequency the listening device is tuned to. The wireless device may identify the frequency and transmit the frequency and its unique listening device identifier to the remote computer 508. The remote computer may compare the frequency to a list of assigned frequencies by the Federal Communications Commission (FCC) to determine the broadcast station identifier assigned to the frequency 510. As assigned frequencies may be duplicated by region, there may be remote computers located in various geographical regions. In each listening device in that geographical area, the processor in the listening device may only permit the listening device to call the assigned telephone number of the remote computer for that geographical area. The remote computer may compile the data and periodically provide a running log to third parties, such as advertisers.

Once the radio station identifier is determined, the remote computer may log this data in a database according to the unique identifier as described above. In additional to the radio station identifier, the data may also include the geographic area the listening device was in when it was polled and the time and day it was polled 512. All data received by the remote computer may be recorded and identified as coming from the listening device with its unique serial number and/or telephone number. In one embodiment, only the serial number of the radio receiver may be recorded or logged by the remote computer to ensure anonymity. The telephone number may be used to authenticate the listening device and may be permanently deleted from the system after authentication is complete. As the remote computer creates a log, over time, only the serial number of the radio receiver may be used to protect anonymity.

After all the data has been logged, communication between the listening device and the remote computer may be terminated 514. If the listening device is then powered down/turned off 516, data gathering may be ended 518. Otherwise, communication may be re-established between the listening device and the remote computer at the predetermined intervals as described above.

In an alternative embodiment, the listening device may initiate communication with the remote computer upon its changing frequency. Data may then be collected as described above.

In an alternative embodiment, the listening device may extract the station call letters by known methods in the art. The station call letters may then be transmitted to the remote computer and logged. By extracting the station call letters, the remote computer does not have to look up this information, saving time.

When transmitting the data to the remote computer, the data may be digitally encoded prior to transmission. Upon receipt at the remote computer, the encoded data may decode the data and store the data in accordance with the unique identifier of the listening device. In an alternative embodiment, the identified frequency may be converted to tones which may be transmitted to the remote computer. Upon receiving the tones, the remote computer may decode and store the tones.

If the remote computer sends a polling command to the listening device and does not receive a response from the listening device, the remote computer may assume that the listening device has been turned off. However, the remote computer may periodically poll the remote computer in case the listening device was in an area with poor reception and did not receive the command.

In one embodiment, the listening device may be programmed to automatically call the remote computer at predetermined intervals, such as every one to three minutes, without having to be prompted by the remote computer. This may be done at specific times of the day, such as during prime time broadcasts.

Listeners may volunteer for their listening devices to participate in the Audience Size Measurement System described above. Alternatively, a sticker on the front of the listening device may suggest that if the listener is so inclined the listener may press a series of buttons on the Front Panel to hear a description of the Audience Size Measurement Program, or call an 800 number operator who would describe the rewards and advantages of the Program. The listener may also refuse to participate in the Audience Size Measurement Program.

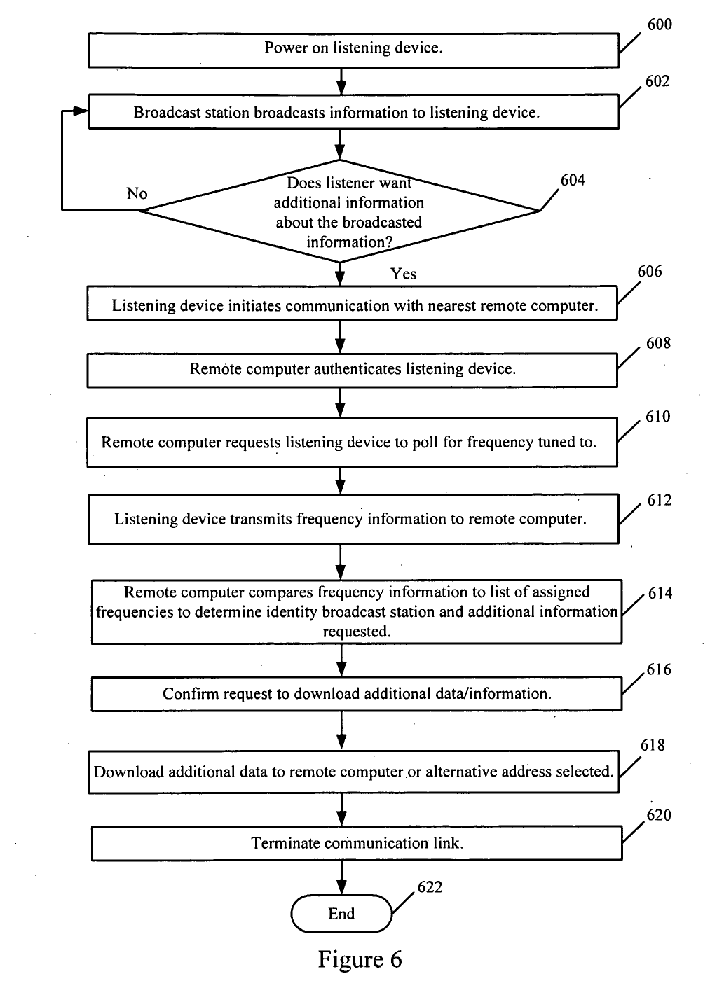

FIG. 6 is a flow diagram illustrating a method for responding to information broadcast on a listening device. Initially a listener powers on a listening device 600 and information, such as music, talk radio, video, advertisements and the like, may be broadcast from broadcasting stations to the listening device 602. While listening to the broadcast, the listener may want to respond to the broadcast, request additional information or purchase a product or service. Additionally, the system and method of the present application may also provide the listener the ability to respond to opinion polls, such as political polls, download driving directions, download messages, make and receive telephone calls, upload the listener's current geographical location and/or upload data or music currently created or previously stored.

It may be determined if the listener would like to respond to, or receive additional information from, a radio broadcast 604. If the listener decides to respond to a radio broadcast, the listener may initiate communication with the nearest remote computer via the listening device 606. (The remote computer may be programmed to identify listening devices within a specific geographic region or area.) Alternatively, if the listener does not wish to receive additional information, the broadcast station may continue to broadcast information to the listener 602.

To initiate communication, the listener may enter a pre-determined sequence of numbers, such as 1325, using the buttons on the front panel (See FIG. 4) of the listening device. In one embodiment, the listening device may require that the code be entered within a specific period of time, such as 3-5 seconds, in order to distinguish other commands entered by using the buttons. Once the code is entered, the remote computer may use it to verify or authenticate the listening device 608. That is, each listening device may receive the specified code prior to establishing communication with the remote computer. Once the listening device has been authenticated, the remote computer may receive the request for additional data from the listening device.

A command may be sent from the remote computer, to the listening device requesting the listening device poll for the radio station frequency to which it is tuned 610. The listening device may determine the frequency it is tuned to and transmit the frequency information to the remote computer 612. As described above, the radio/broadcast station may be determined by comparing the frequency information to a list of assigned frequencies by the FCC or extracting the radio station identifier from the data 614. The identified radio station frequency may be digitized and digitally encoded by an analog to digital converter and transmitted to the remote computer. The remote computer may decode the encoded broadcast station identification data and log chronological data. The advertiser may have collaborated with the operator of the remote computer, and may have disclosed which broadcast stations have run the ad and at specified times. Therefore, remote computer and the advertiser may be knowledgeable of which ad the listener has responded to.

As described above, the remote computer may identify the particular radio station by comparing FCC assigned frequencies to the frequency data decoded by the remote computer. As assigned frequencies may be duplicated by region, multiple remote computers may be placed in each geographical region.

When a listener responds to information, he may be interested in receiving additional information or may want to order a product or service that is being advertised. The display and speaker on the wireless device may request the listener to clarify or confirm what is requested by pressing button(s) on the front panel of the listening device that may be assigned to specific features 616. For example, the listener may be requested to enter “1” for receiving additional information, entering “2” for purchasing a product, etc.

If the listener requests additional information, the additional information may be downloaded to an external device, as described above, or may be downloaded to a specific address. The listener may be prompted to select a location to download the information or the location may be predetermined. Once the location is selected, the downloading of information may commence 618. If, for example, the download location selected was local, and if an MP3 player was plugged in to the listening device, the audio file or information may be downloaded directly to the MP3 player. If the information was downloaded to a remote location, the address previously provided to the system may be used. For example, if the listener has set up a Pay Pal™ account or an iTunes™ account for purchasing and downloading data, the address the listener provided to that account may be used.

To generate revenue, the advertiser may pay, or be charged, a fee for each request for additional information that is downloaded and a fee for any products or services that are ordered. For example, the advertiser of the products/services, by prior agreement, could be charged for the download, thus monetizing the advertisement. Alternatively, this information may be provided free of charge. In one embodiment, the advertisement may be political in nature or may request other personal information. In such a situation, the listener may request that a download be made to the listening device so that no information would be divulged by the remote computer to any third party entities, such as advertisers.

If the information to be downloaded or the product to be shipped is being sold, the prices for the sale may be displayed on the display of the listening device and/or announced though the speaker system included in, or attached to, the listening device. The listener may then be prompted, either visually or audibly, to either accept or decline the purchase. If the listener confirms the purchase, he may be requested to enter a pin number prior to the completion of the transaction to verify his authority to make such a purchase. Once the correct pin number is entered, confirmation may be transmitted to the remote computer, the communication link may be terminated 620 and the transaction is complete 622.

In one embodiment, a third party, such as an advertiser may have made prior arrangements to store the additional information in its Associated Library or database so that the remote computer may immediately download the information when requested. Alternatively, by prior arrangement, the remote computer may communicate the listening device request to the advertiser, who may conduct the balance of the operation from its facility. In either case, the advertiser of the products/services, by prior agreement, could be charged for the download, thus monetizing the advertisement.

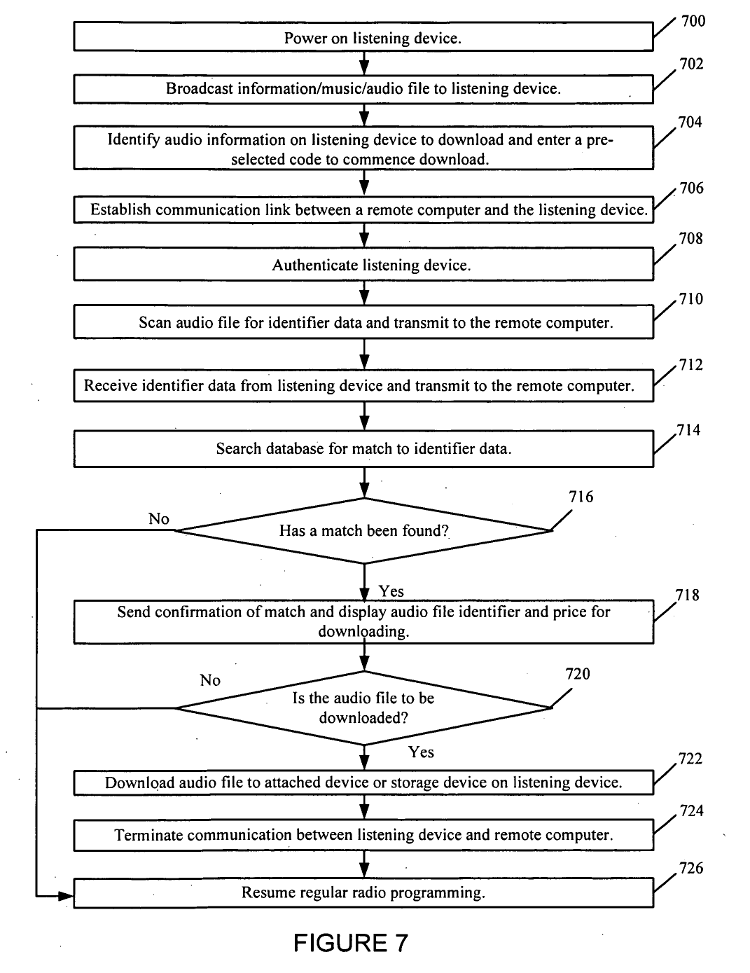

FIG. 7 is a flow diagram illustrating a method for downloading an audio file or information to a listening device. Initially, the listening device is turned on by a user 700 and information, such as music, from broadcasting stations may be broadcast to the listening device 702. If the listener hears an audio file, such as a song, that he is interested in and would like to obtain, either by purchasing or it is available at no cost, the listener may enter a predetermined sequence of numbers, for example 1325, 704.

Upon entering the predetermined sequence of numbers, the listening device may establish a wireless communication link with the remote computer 706. Next, the listener may be prompted to enter a second predetermined sequence of numbers using the alpha-numeric buttons on the front panel of the radio, as described above, for security purposes. The pin number entered may be sent to the processing circuit in the listening device, and subsequently to the remote computer, to verify or authenticate the listening device, 708.

Next, the listening device may scan the current audio file being broadcast, by known methods in the art, and read the header or tag information of the audio file 710. One prior art method of identifying a song is Verizon's® V-Cast™ cellular telephone system. The listener presses the appropriate button and a 10 second segment of the song is digitized and transmitted to the associated song library. This digitized segment is compared to hundreds of thousands of songs that have previously been digitized. When a match is made the song is presented on the cellular phone screen for confirmation, and a price for the download is displayed. If the listener is so inclined, the song may be downloaded to the cellular phone memory chip for future use

The header information may include the name of the artist or band and the music label that distributes the song and may be sent to the interface control logic from the radio receiver tuner. Once the identifying information is obtained, it may be transmitted to the remote computer 712.

Next, the remote computer may search 714 its internal or external storage device, such as an Associated Library or database of songs, and seek a match for the identifier data 716.

An “Associated Library” may include libraries or means of communications to proprietary libraries that would compensate music labels, artists, copyright owners, or others who have already entered into agreements with owners of copyrighted materials, as well as open source libraries that house materials that are not copyright protected.

If a match is found for the requested audio file to be downloaded, the prices for the sale may be displayed on the display of the listening device and/or announced though the speaker system attached to, or included in, the listening device 718. The listener may then be prompted, either visually or audibly, to either accept or decline the purchase 720. If the listener confirms the purchase, he may be requested to enter a pin number prior to the completion of the transaction to verify his authority to make such a purchase. To purchase the audio file, the listener may have previously opened an account for managing audio file downloads, such as iTunes™ by Apple™ Computer or VCAST™ by Verizon™ and that account may be used to purchase the audio file. Alternatively, the listener may use a credit card reader that may be associated to the listening device to pay for the audio files on a per occasion basis.

Once the correct pin number is entered, confirmation may be transmitted to the remote computer and the transaction is completed and the remote computer may commence downloading the song which may be encoded in a pre-selected format, whether proprietary or non-proprietary 722. The listening device may receive the encoded audio data and transfer it to the appropriate port or jack. In the event the music is in a proprietary format such as Apple® iTunes™ format, an IPOD™, which is plugged in to the proprietary jack, accepts the song, and the song is stored in the IPOD™. If an IPOD™ had been plugged in to the IPOD™ jack, the jack connection would have indicated to the processing circuit that the requested song must have the proprietary format for downloading. Similarly, a generic device that is plugged into a Generic Music Download Port (GMDP) that is configured to play multiple formats would so indicate to the processing circuit.

Once the audio data has been downloaded, the communication link is terminated 724 and the radio resumes normal programming 726. If a match is not found or if the pin number is incorrect, the radio also resumes normal programming 726.

In an exemplary embodiment, if the pin number is not entered within a specific time period, for example three seconds, normal programming may not be interrupted.

In another embodiment, a participating radio station may transmit to the remote computer the audio information that was played at a particular time. In such a situation, the header or tag extraction may not be necessary as when the listener commences communication, the call is time stamped. The time stamp may be compared to a list that the participating radio station has provided, along with the time of day that the audio information was played, to find a match.

One or more of the components, steps, and/or functions illustrated in FIGS. 1, 2, 3, 4, 5, 6, and/or 7 may be rearranged and/or combined into a single component, step, or function or embodied in several components, steps, or functions without affecting the operation of the communication device having channel-specific signal insertion. Additional elements, components, steps, and/or functions may also be added without departing from the invention. The apparatus, devices, and/or components illustrated in FIGS. 1, 2, 3 and/or 4 may be configured to perform one or more of the methods, features, or steps described in FIGS. 5, 6 and/or 7. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad application, and that this application is not be limited to the specific constructions and arrangements shown and described, since various other modifications may occur to those ordinarily skilled in the art.

1. A method for collecting audience data, comprising:
establishing a wireless communication link between a remote computer and at least one listening device;
polling the at least one listening device to identify a broadcast frequency that the at least one listening device is tuned to;
transmitting the broadcast frequency, over the wireless communication link, to the remote computer;
comparing the broadcast frequency to a list of assigned frequencies to determine a broadcast station identifier corresponding to the broadcast frequency; and
storing the broadcast station identifier in a database.

2. The method of claim 1, wherein each of the at least one listening device has a unique identifier.

3. The method of claim 2, further comprising:
transmitting the unique identifier, along with the broadcast frequency, to the remote computer; and
adding the unique identifier to a device list in the remote computer, the unique identifier used as an address in the database for storing the broadcast station identifier.

4. The method of claim 3, further comprising storing additional data related to the at least one listening device at the same address in the database.

5. The method of claim 4, wherein the additional data includes day, time and geographic area of the at least one listening device when the broadcast frequency is identified.

6. The method of claim 1, further comprising terminating the wireless communication link between the at least one listening device and the remote computer after transmitting the broadcast frequency and the unique identifier.

7. The method of claim 1, further comprising:
polling the at least one listening device at the predetermined intervals to identify a current broadcast frequency that the at least one listening device is tuned to, wherein the current broadcast frequency may be the same broadcast frequency or a different broadcast frequency then when previously polled.

8. The method of claim 1, further comprising evaluating the data to determine activity data.

9. The method of claim 1, further comprising compiling the data for a specific broadcast station, or a plurality of broadcast stations.

10. A remote computer, comprising:
a memory device; and
a processor coupled with the memory device, the processor configured to
poll at least one listening device, at predetermined intervals, to identify a broadcast frequency that the at least one listening device is tuned to, or a different broadcast frequency then when previously polled;
receive the broadcast frequency from the at least one listening device
compare the broadcast frequency to a list of assigned frequencies to determine a broadcast station identifier corresponding to the broadcast frequency; and
store the broadcast station identifier in a database.

11. The remote computer of claim 10, wherein each of the at least one listening device has a unique identifier, the unique identifier is used as an address in the database for storing the broadcast station identifier.

12. The remote computer of claim 10, wherein a wireless communication link is established between the remote computer and the at least one listening device.

13. The remote computer of claim 11, wherein the processor is further configured to:
define the predetermined intervals for polling the at least one listening device.

14. The remote computer of claim 10, wherein the wireless communication link between the at least one listening device and the remote computer is terminated after the broadcast frequency and the unique identifier are received.

15. The remote computer of claim 10, wherein the processor is further configured to:
compile the data for a specific broadcast station or a plurality of broadcast stations.

16. A method for interacting with a listening device, comprising:
establishing a wireless communication link between a remote computer and a listening device, the wireless communication link being established in response to a listener entering a pre-determined sequence of numbers;
requesting additional information related to a broadcast on the listening device;
determining the broadcast station the listening devices is tuned to by identifying a broadcast frequency;
comparing the broadcast frequency to a list of assigned frequencies to determine a broadcast station identifier corresponding to the broadcast frequency;
identifying broadcast information for which additional information is being requested; and
transmitting the additional information to the listener.

17. The method of claim 16, further comprising:
downloading the additional information to an external device attached to the listening device or to specific Internet address.

18. The method of claim 16, wherein the broadcast information is an advertisement and the additional information associated with the broadcast information is stored in a database of the remote computer so that the additional information is immediately downloaded upon request.

19. The method of claim 18, wherein the listener is requested to confirm the download of the additional information verbally through speakers of the listening device.

20. The method of claim 16, further comprising:
establishing an agreement between the broadcast station and an advertiser of the additional information; and
charging the advertiser for each instance the additional information is downloaded.
